(19) United States
(12) Patent Application Publication
(10) Pub. No.: US 2011/0187966 A1
(43) Pub. Date: Aug. 4, 2011

(54) LIQUID CRYSTAL DISPLAY DEVICE

(75) Inventor: Masashi Yokota, Osaka-shi (JP)

(73) Assignee: SHARP KABUSHIKI KAISHA, Osaka-shi, Osaka (JP)

(21) Appl. No.: 13/122,562

(22) PCT Filed: May 29, 2009
(86) PCT No.: PCT/JP2009/059846

§ 371 Date: Apr. 5, 2011

(30) Foreign Application Priority Data
Oct. 24, 2008 (JP) 2008-274507

(51) Int. Cl. G02F 1/1335

(52) U.S. Cl. 349/62

(57) ABSTRACT

A liquid crystal display device (1) is provided with a lens sheet (10) that includes a low refractive index layer (11) having a low refractive index of a predetermined refractive index or lower and a high refractive index layer (12) having a refractive index higher than that of the low refractive index layer (11) and provided integrally with the low refractive index layer (11). Further, in the lens sheet (10), among a pair of polarizing plates (7, 8), the low refractive index layer (11) is attached to the polarizing plate (8) that is provided on an illumination device (3) side while being in intimate contact with the polarizing plate (8).

### TECHNICAL FIELD

The present invention relates to a liquid crystal display device that displays information such as characters and images.

### BACKGROUND ART

Recently, for example, liquid crystal display devices have been used widely in liquid crystal televisions, monitors and mobile telephones, as flat panel displays having features such as thinness and lightness, compared with conventional Braun tubes. Such a liquid crystal display device includes an illumination device (backlight) emitting light and a liquid crystal panel displaying a desired image by playing a role of a shutter with respect to light from light sources provided in the illumination device.

Further, in the conventional liquid crystal display device, as described in Patent Document 1 identified below for example, an illumination device includes a reflection-type polarizing plate that only transmits P-polarized light among light from a light source, a diffusion sheet that modulates the P-polarized light from the reflection-type polarizing plate by the refraction aeolotropy, and a phase difference plate that controls a phase difference so that the component of the polarized light modulated by the diffusion sheet is compensated to linear polarized light. Further, in this conventional liquid crystal display device, the component of the P-polarized light having passed through the phase difference plate is collected by a prism sheet and allowed to be incident upon a liquid crystal panel via a polarizing plate whose axis is adapted to P-polarized light. Thus, in this conventional liquid crystal display device, the light incidence efficiency toward the liquid crystal panel is improved, whereby high-luminance display is realized.

### PRIOR ART DOCUMENT

### Patent Document

Patent Document 1: JP 2002-231027 A

### DISCLOSURE OF INVENTION

### Problem to be Solved by the Invention

However, the conventional liquid crystal display device as described above sometimes causes a problem that a contrast of information displayed on the liquid crystal panel is decreased and accordingly the display quality is decreased.

Specifically, in the conventional liquid crystal display device, incident light incident into the liquid crystal panel is incident at various angles with respect to a normal direction in a display surface of the liquid crystal panel. Because of this, in the liquid crystal panel of the conventional liquid crystal display device, when a black display is performed per line for example, light from portions not displayed in black sometimes is output from a display line displayed in black to the outside, which increases a luminance of the display line displayed in black and decreases the contrast. Especially in the conventional liquid crystal display device, when an anti-glare treatment (anti-reflection treatment) is performed with respect to a polarizing plate provided on a display surface side of the liquid crystal panel, the incident light toward the liquid crystal panel is refracted easily due to a random surface of the polarizing plate. Accordingly, light that is supposed to pass obliquely from a normal line direction is bent to the normal line direction, which increases the black luminance and often decreases the contrast. Consequently, the conventional liquid crystal display device sometimes causes a decrease in display quality.

In view of the above-described problems, it is an object of the present invention to provide a liquid crystal display device capable of preventing a decrease in contrast and hence having excellent display quality.

### Means for Solving Problem

In order to achieve the above-described object, a liquid crystal display device according to the present invention is a liquid crystal display device that includes a liquid crystal panel provided with a liquid crystal layer, a pair of substrates sandwiching the liquid crystal layer therebetween and a pair of polarizing plates attached to the pair of substrates in such a manner as to sandwich the pair of substrates therebetween, and an illumination device provided to face one of the pair of polarizing plates and emitting illumination light toward the liquid crystal panel, comprising: a lens sheet that includes a low refractive index layer having a low refractive index of a predetermined refractive index or lower, and a high refractive index layer having a refractive index higher than that of the low refractive index layer and provided integrally with the low refractive index layer, wherein in the lens sheet, the low refractive index layer is attached to one of the pair of polarizing plates that is provided on the illumination device side while being in intimate contact with the polarizing plate.

In the liquid crystal display device configured as above, the inventor of the present invention has found that, by providing the low refractive index layer and the high refractive index layer integrally in the lens sheet and attaching the lens sheet to the polarizing plate on the illumination device side in a state where the low refractive index layer is in intimate contact with the polarizing plate, light from the illumination device can be aligned in the normal direction in the display surface of the liquid crystal panel and incident into the liquid crystal panel. In other words, the inventor of the present invention has obtained that, by providing the low refractive index layer and the high refractive index layer integrally, the light from the illumination device can be aligned in the normal direction at an interface between the low refractive index layer and the high refractive index layer. The inventor further has obtained that, by bringing the low refractive index layer into intimate contact with the polarizing plate on the illumination device side, the light can be incident into the liquid crystal panel while being aligned in the normal direction. The present invention has been accomplished based on the findings as described above, and unlike the above-described conventional example, it is possible to obtain a liquid crystal display device capable of preventing a decrease in contrast and hence having excellent display quality.

Further, in the above-described liquid crystal display device, the high refractive index layer may include a prism sheet having a plurality of triangular bars arranged in a predetermined direction.

In this case, light from the illumination device can be aligned reliably in the normal direction at an interface between the prism sheet having a plurality of triangular bars and the low refractive index layer.

Further, in the above-described liquid crystal display device, the high refractive index layer may include a lenticular lens sheet having a plurality of convex lenses arranged in a predetermined direction.

In this case, light from the illumination device can be aligned reliably in the normal direction at an interface between the lenticular lens sheet having a plurality of convex lenses and the low refractive index layer.

Further, in the above-described liquid crystal display device, the high refractive index layer preferably includes a plurality of lenses formed in convex shapes.

In this case, since the high refractive index layer includes a plurality of lenses formed in convex shapes, light from the illumination device can be aligned reliably in the normal direction and the light collecting property is increased.

Further, in the above-described liquid crystal display device, in the lens sheet, a light incident layer having a refractive index lower than that of the high refractive index layer preferably is provided integrally with the high refractive index layer on the illumination device side of the high refractive index layer.

In this case, since the light incident layer is provided integrally with the high refractive index layer on the illumination device side of the high refractive index layer, light from the illumination device can be incident upon the high refractive index layer smoothly, and hence the light use efficiency of the illumination device can be improved easily.

### Effect of the Invention

According to the present invention, it is possible to provide a liquid crystal display device capable of preventing a decrease in contrast and hence having excellent display quality.

### BRIEF DESCRIPTION OF DRAWINGS

FIG. 1 is a schematic cross-sectional view illustrating a liquid crystal display device according to Embodiment 1 of the present invention.

FIGS. 2A and 2B respectively are a perspective view and a side view of a high refractive index layer shown in FIG. 1.

FIG. 3 is a schematic cross-sectional view illustrating a liquid crystal display device according to Embodiment 2 of the present invention.

FIGS. 4A and 4B respectively are a partial perspective view and a plan view of a high refractive index layer shown in FIG. 3.

FIG. 5 is a schematic cross-sectional view illustrating a liquid crystal display device according to Embodiment 3 of the present invention.

FIG. 6 is a perspective view of a high refractive index layer shown in FIG. 5.

FIG. 7 is a schematic cross-sectional view illustrating a liquid crystal display device according to Embodiment 4 of the present invention.

FIGS. 8A and 8B respectively are a partial perspective view and a side view of a high refractive index layer shown in FIG. 7.

### DESCRIPTION OF PREFERRED EMBODIMENT

Hereinafter, preferred embodiments of a liquid crystal display device of the present invention will be described with reference to drawings. In the following description, the case where the present invention is applied to a transmission-type liquid crystal display device will be described. Further, the dimensions of constituent members in the drawings do not faithfully reflect the actual dimensions of constituent members, dimension ratio of the respective constituent members, etc.

### Embodiment 1

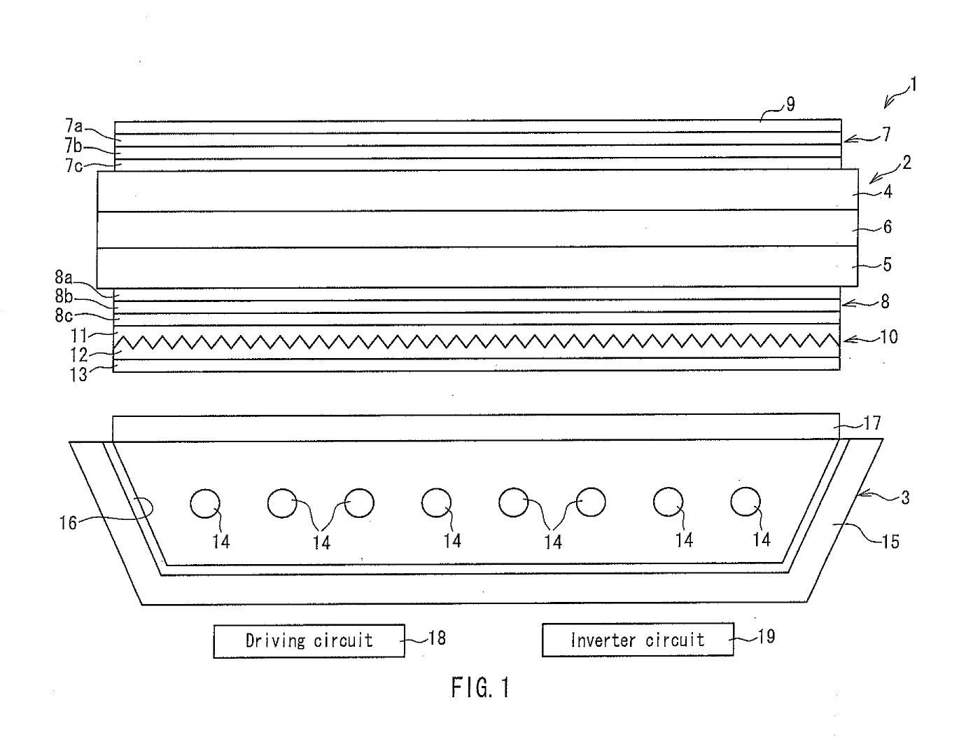

FIG. 1 is a schematic cross-sectional view illustrating a liquid crystal display device according to Embodiment 1 of the present invention. In FIG. 1, a liquid crystal display device 1 of the present embodiment is configured using a display element of the present invention, and includes a liquid crystal panel 2 that is located with the upper side in FIG. 1 defined as a viewing side (display surface side) and an illumination device 3 that is arranged on a non-display surface side of the liquid crystal panel 2 (lower side in FIG. 1) and that generates illumination light for illuminating the liquid crystal panel 2.

The liquid crystal panel 2 includes: a CF (Color Filter) substrate 4 and an array substrate 5 constituting a pair of substrates; a liquid crystal layer 6 sandwiched by the CF substrate 4 and the array substrate 5; and polarizing plates 7 and 8 provided respectively on outer surfaces of the CF substrate 4 and the array substrate 5 in such a manner as to sandwich the CF substrate 4 and the array substrate 5. Further, in the liquid crystal panel 2, a lens sheet 10 of the present embodiment is provided integrally with the polarizing plate 8 that is on the illumination device 3 side, so as to align the illumination light from the illumination device 3 in a normal direction in the display surface of the liquid crystal panel 2 (vertical direction in FIG. 1) (the detail will be described later).

In the CF substrate 4 and the array substrate 5, a planar glass material or a transparent synthetic resin such as an acrylic resin is used. Further, on the array substrate 5, pixel electrodes, TFTs (Thin Film Transistor) and the like (not shown) are formed between the array substrate 5 and the liquid crystal layer 6 in such a manner as to correspond to a plurality of pixels contained in the display surface of the liquid crystal panel 2. Meanwhile, on the CF substrate 4, color filters, counter electrodes and the like (not shown) are formed between the CF substrate 4 and the liquid crystal layer 6.

Note here that the liquid crystal panel 2 may be in any liquid crystal mode and have any pixel structure. Further, the liquid crystal panel 2 may be in any drive mode. In other words, the liquid crystal panel 2 may be any liquid crystal panel that can display information. Thus, a detailed structure of the liquid crystal panel 2 is not shown in FIG. 1, and a description thereof will be omitted.

The polarizing plate 7 includes, for example, a PVA (polyvinyl alcohol) film 7b having a predetermined polarization property and TAC (triacetylcellulose) films 7a, 7c disposed to sandwich the PVA film 7b. In the polarizing plate 7, the TAC film 7c is attached to a surface of the CF substrate 4. Further, an antireflection film 9 containing beads or the like is bonded integrally to the display surface side of the TAC film 7a, as a surface treated film.

Similarly, the polarizing plate 8 includes, for example, a PVA film 8b having a predetermined polarization property and TAC films 8a, 8c disposed to sandwich the PVA film 8b. In the polarizing plate 8, the TAC film 8a is attached to a surface of the array substrate 5. Further, the above-described lens sheet 10 is bonded integrally to the non-display surface side of the TAC film 8c.

These polarizing plates 7 and 8 are bonded to the corresponding CF substrate 4 or array substrate 5 in such a manner as to cover at least an effective display area of the display surface in the liquid crystal panel 2.

Besides the above description, in the polarizing plates 7 and 8, phase difference plates may be used in place of the TAC films 7c and 8a.

The illumination device 3 includes a plurality of cold cathode fluorescent tubes (CCFL) 14 and a bottomed chassis 15 containing the cold cathode fluorescent tubes 14. On an inner surface of the chassis 15, for example, a reflecting sheet 16 is located to improve the light use efficiency of the cold cathode fluorescent tubes 14 by reflecting light from the cold cathode fluorescent tubes 14 (light sources) toward the liquid crystal panel 2 side. Further, on an opening of the chassis 15, a diffusion plate 17 is located to cover the opening.

Further, each of the cold cathode fluorescent tubes 14 is of a straight-tube type, and electrode portions (not shown) provided at both ends thereof are supported outside the chassis 15. Further, each of the cold cathode fluorescent tubes 14 is configured to have a small diameter of about 3.0 to 4.0 mm so as to have excellent light-emission efficiency, whereby the illumination device 3 that is compact and that has excellent light-emission efficiency is obtained easily. Further, the cold cathode fluorescent tubes 14 are held inside the chassis 15 while being kept at predetermined distances from the reflecting sheet 16 and the diffusion plate 17 by a light source holder (not shown).

The diffusion plate 17 is made of, for example, a rectangular-shaped synthetic resin or glass material having a thickness of about 2 mm. The illumination device 3 is configured so that light from the cold cathode fluorescent tubes 14 is incident upon the lens sheet 10 via the diffusion plate 17. Besides the above description, an optical sheet such as a prism (collecting) sheet for increasing the luminance is located between the lens sheet 10 and the diffusion plate 17.

Further, a driving circuit 18 for driving the liquid crystal panel 2 and an inverter circuit 19 for switching on each of the plurality of the cold cathode fluorescent tubes 14 at high frequency by inverter driving are located outside the chassis 15.

Although the above description is directed to the configuration using the direct-type illumination device 3, the present embodiment is not limited thereto and an edge-light type illumination device having a light guiding plate may be used. Further, an illumination device having light sources other than the cold cathode fluorescent tubes, such as a hot cathode fluorescent tube and an LED, can be used.

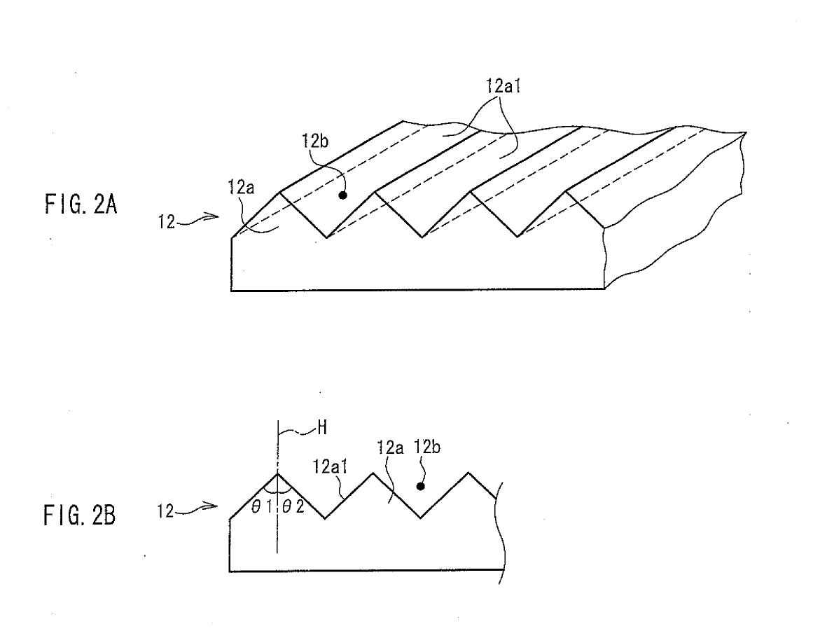

Here, the lens sheet 10 of the present embodiment will be described specifically with reference to FIG. 2.

FIGS. 2A and 2B respectively are a perspective view and a side view of a high refractive index layer shown in FIG. 1.

As shown in FIG. 1, the lens sheet 10 includes a low refractive index layer 11 having a low refractive index of a predetermined refractive index or lower, a high refractive index layer 12 having a refractive index higher than that of the low refractive index layer 11, and a light incident layer 13 having a refractive index lower than that of the high refractive index layer 12.

Specifically, in the low refractive index layer 11, a transparent synthetic resin having a refractive index of 1.0 or more and 1.6 or less (e.g., a polycarbonate resin, a polystyrene resin or a polypropylene resin) is used. In the high refractive index layer 12, the above-described transparent synthetic resin having a refractive index of 1.4 or more and 2.0 or less is used. Further, in the light incident layer 13, the above-described transparent synthetic resin having a refractive index of 1.0 or more and 1.6 or less is used.

In the lens sheet 10, the low refractive index layer 11 and the high refractive index layer 12 are provided integrally, and the high refractive index layer 12 and the light incident layer 13 are provided integrally. Further, in the lens sheet 10, the high refractive index layer 12 is configured using, for example, a prism sheet having a cross-section with triangular shapes protruding toward the liquid crystal panel 2 side. Moreover, the low refractive index layer 11 is attached to the polarizing plate 8 provided on the illumination device 3 side while being in intimate contact with the polarizing plate 8.

That is, the high refractive index layer 12 includes a prism sheet having a plurality of triangular bars arranged in a predetermined direction (vertical direction of the sheet of FIG. 1). Specifically, as shown in FIG. 2, the high refractive index layer 12 includes triangular prisms 12a and prism grooves 12b that are provided between prism surfaces 12a1 of two adjacent prisms 12a. Thus, each of the plurality of prisms 12a forms the above-described triangular bar.

As shown in FIG. 2B, a vertex of each prism 12a in the high refractive index layer 12 is formed to have predetermined angles θ1 and θ2 with respect to the normal direction in the display surface of the liquid crystal panel 2 (illustrated by “H” in FIG. 2B). Specific ranges of these angles are from 35° to 55°, respectively. The high refractive index layer 12 is attached to the liquid crystal panel 2 side via the low refractive index layer 11 and emits light of the illumination device 3 incident from the light incident layer 13 toward the liquid crystal panel 2 side.

Further, the lens sheet 10 is configured so that, by setting the angles θ1 and θ2 of the vertex of each prism 12a in the high refractive index layer 12 to be in the above-described range, the light of the illumination device 3 incident from the light incident layer 13 can be aligned at an interface between the low refractive index layer 11 and the high refractive index layer 12, as light parallel to the normal direction H. The angles θ1 and θ2 may be same or different from each other as long as they are within the above-described range.

In the liquid crystal display device 1 of the present embodiment configured as above, the lens sheet 10 in which the low refractive index layer 11 and the high refractive index layer 12 are provided integrally is located. Further, in the lens sheet 10, the low refractive index layer 11 is attached to the polarizing plate 8 on the illumination device 3 side while being in intimate contact with the polarizing plate 8. Thus, in the liquid crystal display device 1 of the present embodiment, at the interface between the low refractive index layer 11 and the high refractive index layer 12 in the lens sheet 10, the light from the illumination device 3 is aligned in the normal direction in the display surface of the liquid crystal panel 2. Further, in the liquid crystal display device 1 of the present embodiment, the lens sheet 10 allows the light from the illumination device 3 to be incident into the liquid crystal panel 2 while aligning the light in the normal direction. As a result, in the present embodiment, even if the antireflection film 9 containing beads or the like is provided with respect to the polarizing plate 7 that is on the display surface side of the liquid crystal panel 2, unlike the above-described conventional example, it is possible to obtain the liquid crystal display device 1 capable of preventing a decrease in contrast and hence having excellent display quality.

Further, in the liquid crystal display device 1 of the present embodiment, at the interface between the low refractive index layer 11 and the high refractive index layer 12 including the above-described prism sheet, the light from the illumination device 3 is aligned reliably in the normal direction.

### Embodiment 2

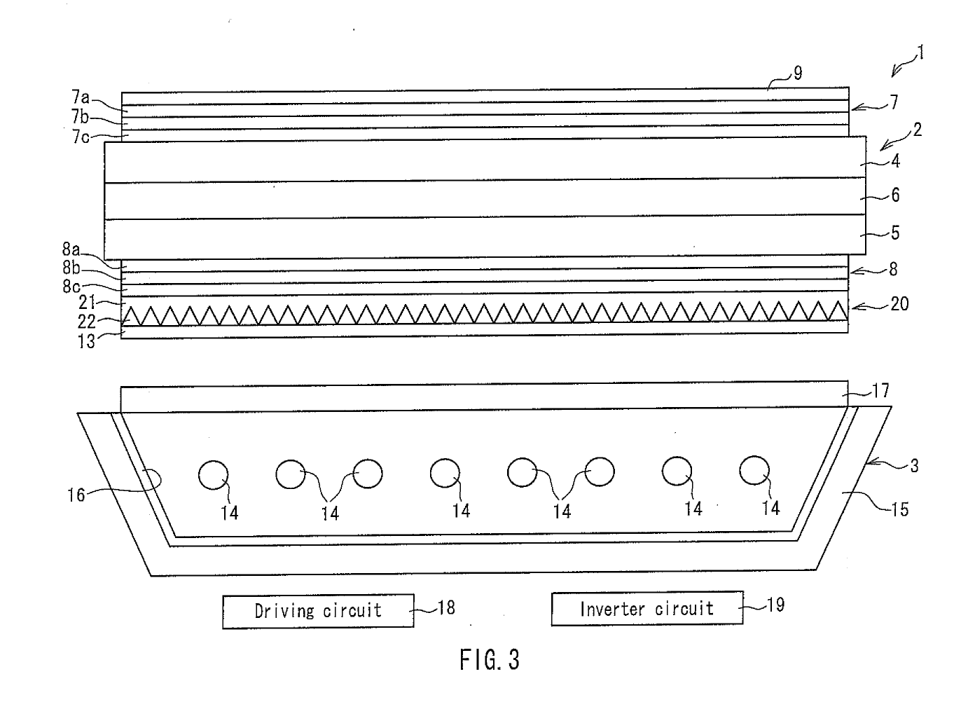

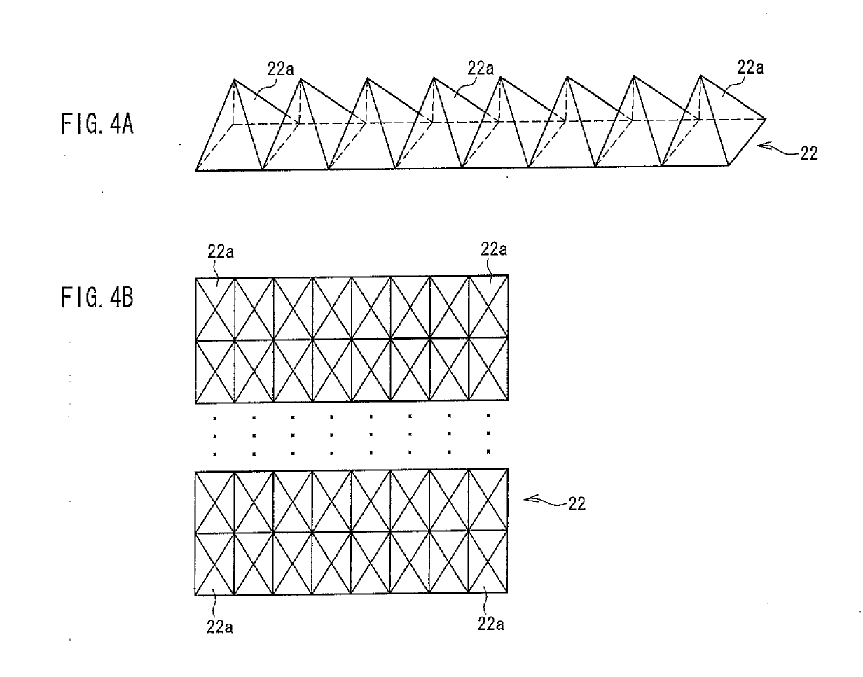

FIG. 3 is a schematic cross-sectional view illustrating a liquid crystal display device according to Embodiment 2 of the present invention. FIGS. 4A and 4B respectively are a partial perspective view and a plan view of a high refractive index layer shown in FIG. 3. In the drawings, a main difference between the present embodiment and the above-described Embodiment 1 is that the high refractive index layer includes a plurality of quadrangular pyramid lenses in place of the prism sheet. Note here that the same components as those of Embodiment 1 are denoted with the same reference numerals as those therein, and repeated descriptions thereof will be omitted.

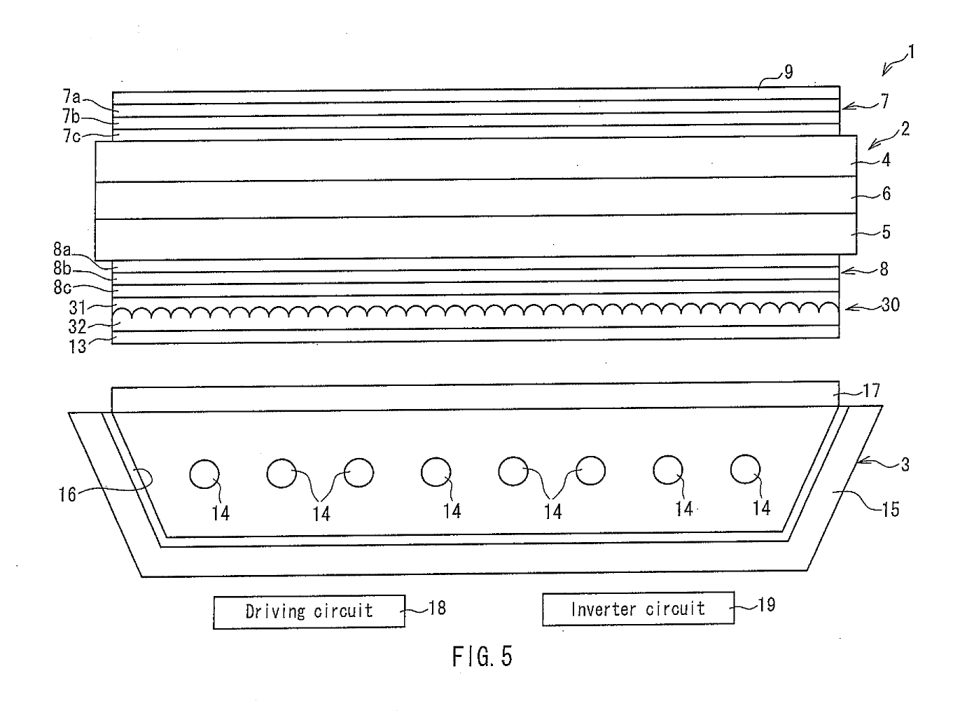

That is, as shown in FIGS. 4A, 4B and 5, a lens sheet 20 of the present embodiment includes a low refractive index layer 21 having a low refractive index of a predetermined refractive index or lower, a high refractive index layer 22 having a refractive index higher than that of the low refractive index layer 21, and a light incident layer 13 having a refractive index lower than that of the high refractive index layer 22. The low refractive index layer 21, the high refractive index layer 22 and the light incident layer 13 are configured using transparent synthetic resins as those in Embodiment 1 and provided integrally in this order.

Further, as shown in FIGS. 4A and 4B, the high refractive index layer 22 includes a plurality of quadrangular pyramid lenses 22a. That is, in the high refractive index layer 22, as shown in FIG. 4B, the plurality of quadrangular pyramid lenses 22a are arranged parallel to horizontal and vertical directions in the display surface of the liquid crystal panel 2. Further, these lenses 22a are formed on the light incident layer 13 and attached to the liquid crystal panel 2 side via the low refractive index layer 21, as those in Embodiment 1. Further, the lens sheet 20 emits light of the illumination device 3 incident from the light incident layer 13 toward the liquid crystal panel 2 side while aligning the light in the normal direction at an interface between the low refractive index layer 11 and the high refractive index layer 12.

With this configuration, the present embodiment can provide the same function and achieve the same effect as those in Embodiment 1. Further, in the present embodiment, since the high refractive index layer 22 includes the plurality of quadrangular pyramid lenses 22a, the light from the illumination device 3 can be collected more in the vertical direction of the sheet of FIG. 3, as compared with the configuration of Embodiment 1. That is, in the present embodiment, as compared with the configuration of Embodiment 1, light can be aligned reliably in the normal direction and the light collecting property of light of the illumination device 3 is increased.

Besides the above description, for example, triangular pyramid lenses may be used.

### Embodiment 31

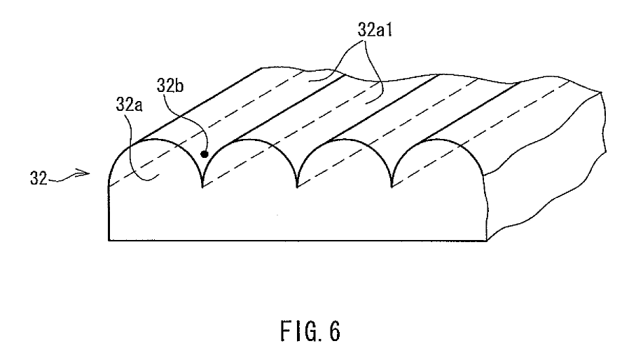

FIG. 5 is a schematic cross-sectional view illustrating a liquid crystal display device according to Embodiment 3 of the present invention. FIG. 6 is a perspective view of a high refractive index layer shown in FIG. 5. In the drawings, a main difference between the present embodiment and the above-described Embodiment 1 is that the high refractive index layer includes a lenticular lens sheet in place of the prism sheet. Note here that the same components as those of Embodiment 1 are denoted with the same reference numerals as those therein, and repeated descriptions thereof will be omitted.

That is, as shown in FIGS. 5 and 6, a lens sheet 30 of the present embodiment includes a low refractive index layer 31 having a low refractive index of a predetermined refractive index or lower, a high refractive index layer 32 having a refractive index higher than that of the low refractive index layer 31, and a light incident layer 13 having a refractive index lower than that of the high refractive index layer 32. The low refractive index layer 31, the high refractive index layer 32 and the light incident layer 13 are configured using transparent synthetic resins as those in Embodiment 1 and provided integrally in this order.

Further, as shown in FIG. 6, the high refractive index layer 32 includes a lenticular lens sheet having a plurality of convex lenses arranged in a predetermined direction (vertical direction of the sheet of FIG. 5). Specifically, as shown in FIG. 6, the high refractive index layer 32 includes lenses 32a having semicircular cross-sections and lens grooves 32b provided between lens surfaces 32a1 of two adjacent lenses 32a. Thus, each of the plurality of lenses 32a forms the above-described convex lens. Further, the high refractive index layer 32 is attached to the liquid crystal panel 2 side via the low refractive index layer 31, as that in Embodiment 1. Further, the lens sheet 30 emits light of the illumination device 3 incident from the light incident layer 13 toward the liquid crystal panel 2 side while aligning the light in the normal direction at an interface between the low refractive index layer 31 and the high refractive index layer 32.

With this configuration, the present embodiment can provide the same function and achieve the same effect as those in Embodiment 1. Further, in the liquid crystal display device 1 of the present embodiment, the light from the illumination device 3 can be aligned reliably in the normal direction at the interface between the low refractive index layer 31 and the high refractive index layer 32 including the lenticular lens sheet.

### Embodiment 4

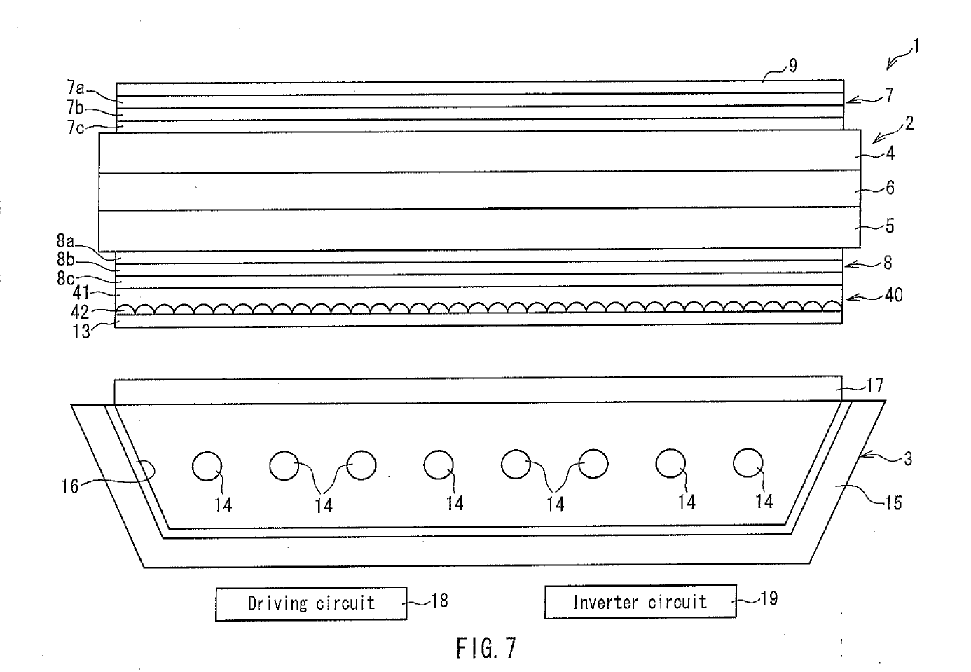

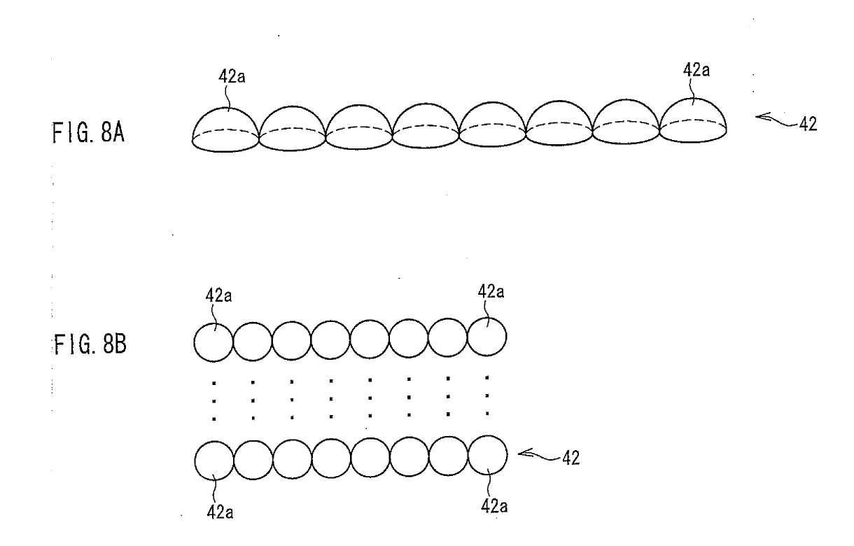

FIG. 7 is a schematic cross-sectional view illustrating a liquid crystal display device according to Embodiment 4 of the present invention. FIGS. 8A and 8B respectively are a partial perspective view and a side view of a high refractive index layer shown in FIG. 7. In the drawings, a main difference between the present embodiment and the above-described Embodiment 3 is that the high refractive index layer includes a plurality of hemispherical lenses in place of the lenticular lens sheet. Note here that the same components as those of Embodiment 3 are denoted with the same reference numerals as those therein, and repeated descriptions thereof will be omitted.

That is, as shown in FIGS. 7, 8A and 8B, a lens sheet 40 of the present embodiment includes a low refractive index layer 41 having a low refractive index of a predetermined refractive index or lower, a high refractive index layer 42 having a refractive index higher than that of the low refractive index layer 41, and a light incident layer 13 having a refractive index lower than that of the high refractive index layer 42. The low refractive index layer 41, the high refractive index layer 42 and the light incident layer 13 are configured using transparent synthetic resins as those in Embodiment 3 and provided integrally in this order.

Further, as shown in FIGS. 8A and 8B, the high refractive index layer 42 includes a plurality of hemispherical lenses 42a. Specifically, in the high refractive index layer 42, as shown in FIG. 8B, the plurality of hemispherical lenses 42a are arranged parallel to the horizontal and vertical directions in the display surface of the liquid crystal panel 2. Further, these lenses 42a are formed on the light incident layer 13 and attached to the liquid crystal panel 2 side via the low refractive index layer 41, as those in Embodiment 3. Further, the lens sheet 40 emits light of the illumination device 3 incident from the light incident layer 13 toward the liquid crystal panel 2 side while aligning the light in the normal direction at an interface between the low refractive index layer 41 and the high refractive index layer 42.

With this configuration, the present embodiment can provide the same function and achieve the same effect as those in Embodiment 3. Further, in the present embodiment, since the high refractive index layer 42 includes the plurality of hemispherical lenses 42a, the light from the illumination device 3 can be collected more in the vertical direction of the sheet of FIG. 7, as compared with the configuration of Embodiment 3. That is, in the present embodiment, as compared with the configuration of Embodiment 3, light can be aligned reliably in the normal direction and the light collecting property of light of the illumination device 3 is increased.

Besides the above description, for example, substantially hemispherical lenses whose bottom faces are oval may be used.

It should be noted that all of the above embodiments are illustrative and not limiting. The technical range of the present invention is defined by the claims, and all the changes within a range equivalent to the configuration recited in the claims also are included in the technical range of the present invention.

For example, although the above description explains the cases where the present invention is applied to the transmission-type liquid crystal display device, the liquid crystal display device of the present invention is not limited thereto, and may be applied to other liquid crystal display devices such as a semi-transmission type and a reflection type.

Further, although the above description explains the configuration in which the light incident layer is provided integrally with the illumination device side of the high refractive index layer, the present invention is not limited thereto as long as a lens sheet in which a low refractive index layer and a high refractive index layer are provided integrally is included, and the low refractive index layer is attached to a polarizing plate provided on a illumination device side while being in intimate contact with the polarizing plate.

As in the above embodiments, the case where a light incident layer is provided integrally with a high refractive index layer is preferable, because this configuration allows light from an illumination device to be incident upon the high refractive index layer smoothly, and hence the light use efficiency of the illumination device can be improved easily.

Further, although the above descriptions of Embodiments 2 and 4 explain the cases where the high refractive index layer is configured by providing the plurality of quadrangular pyramid lenses and hemispherical lenses on the light incident layer, respectively, the lenses of the present invention is not limited thereto as long as a high refractive index layer includes a plurality of lenses formed in convex shapes. For example, it is possible to use a high refractive index layer that includes a planar base material made from the same material as lenses and a plurality of lenses formed on the base material.

### INDUSTRIAL APPLICABILITY

The present invention is useful with respect to a liquid crystal display device capable of preventing a decrease in contrast and hence having excellent display quality.

### DESCRIPTION OF REFERENCE NUMERALS

1 liquid crystal display device
2 liquid crystal panel
3 illumination device
4 CF substrate (pair of substrates)
5 array substrate (pair of substrates)
6 liquid crystal layer
7, 8 polarizing plates
10, 20, 30, 40 lens sheet
11, 21, 31, 41 low refractive index layer
12, 22, 32, 42 high refractive index layer
22a, 42a lens
13 light incident layer

1. A liquid crystal display device that includes a liquid crystal panel provided with a liquid crystal layer, a pair of substrates sandwiching the liquid crystal layer therebetween and a pair of polarizing plates attached to the pair of substrates in such a manner as to sandwich the pair of substrates therebetween, and an illumination device provided to face one of the pair of polarizing plates and emitting illumination light toward the liquid crystal panel, comprising:
a lens sheet that includes a low refractive index layer having a low refractive index of a predetermined refractive index or lower, and a high refractive index layer having a refractive index higher than that of the low refractive index layer and provided integrally with the low refractive index layer,
wherein in the lens sheet, the low refractive index layer is attached to one of the pair of polarizing plates that is provided on the illumination device side while being in intimate contact with the polarizing plate.

2. The liquid crystal display device according to claim 1, wherein the high refractive index layer includes a prism sheet having a plurality of triangular bars arranged in a predetermined direction.

3. The liquid crystal display device according to claim 1, wherein the high refractive index layer includes a lenticular lens sheet having a plurality of convex lenses arranged in a predetermined direction.

4. The liquid crystal display device according to claim 1, wherein the high refractive index layer includes a plurality of lenses formed in convex shapes.

5. The liquid crystal display device according to claim 1, wherein, in the lens sheet, a light incident layer having a refractive index lower than that of the high refractive index layer is provided integrally with the high refractive index layer on the illumination device side of the high refractive index layer.
